(19) United States
(12) Patent Application Publication
(10) Pub. No.: US 2025/0370307 A1
(43) Pub. Date: Dec. 4, 2025

(54) DISPLAY DEVICE

(71) Applicant: E Ink Holdings Inc., Hsinchu (TW)

(72) Inventors: Kun-Hsien Lee, Hsinchu (TW); Ching-Huan Liao, Hsinchu (TW); Hsin-Tao Huang, Hsinchu (TW)

(73) Assignee: E Ink Holdings Inc., Hsinchu (TW)

(21) Appl. No.: 19/204,599

(22) Filed: May 11, 2025

(30) Foreign Application Priority Data
Jun. 3, 2024 (TW) 113120480

(51) Int. Cl. G02F 1/1677; G02F 1/1335; G02F 1/16753

(52) U.S. Cl. CPC G02F 1/1677; G02F 1/133512; G02F 1/133562; G02F 1/16753

(57) ABSTRACT

A display device including a housing, a cover plate, an E-paper display panel, a light source, and a viewing angle limiting structure is provided. The cover plate and the housing define an accommodating space. The cover plate has a visible region and a border region surrounding the visible region. The E-paper display panel is disposed inside the accommodating space and has a display region. In a viewing direction perpendicular to the E-paper display panel, a boundary of the display region is retracted inwardly with respect to a boundary of the visible region, so that the visible region of the cover plate has a center visible region aligned with the display region and a peripheral visible region located between the center visible region and the border region. The light source is disposed inside the accommodating space and located at the border region. A distance between the E-paper display panel and the cover plate is greater than a distance between the light source and the cover plate. The viewing angle limiting structure is located on a light propagating path from a light-emitting surface of the light source to the peripheral visible region of the cover plate.

### CROSS-REFERENCE TO RELATED APPLICATION

This application claims the priority benefit of Taiwan application serial no. 113120480, filed on Jun. 3, 2024. The entirety of the above-mentioned patent application is hereby incorporated by reference herein and made a part of this specification.

### BACKGROUND OF THE INVENTION

### Field of the Invention

The invention relates to an electronic device, and in particular to a display device.

### Description of Related Art

The low energy consumption characteristics of E-paper display panels are beneficial for application in large-sized products. Examples include application in large-sized advertising boards. In this type of application, E-paper display panels may adopt the design architecture of integrated front light source or independent front light source. The design architecture of the integrated front light source means that the light source is integrated with the E-paper display panel, and the design architecture of the independent front light source means that the light source is independently disposed in front of the E-paper display panel.

### SUMMARY OF THE INVENTION

The invention provides a display device that may provide good display effects.

A display device of the invention includes a housing, a cover plate, an E-paper display panel, a light source, and a viewing angle limiting structure. The cover plate is disposed on the housing. The cover plate and the housing define an accommodating space. The cover plate has a visible region and a border region surrounding the visible region. The E-paper display panel is disposed inside the accommodating space, wherein the E-paper display panel has a display region, and in a viewing direction perpendicular to the E-paper display panel, a boundary of the display region is retracted inwardly with respect to a boundary of the visible region, so that the visible region of the cover plate has a center visible region aligned with the display region and a peripheral visible region located between the center visible region and the border region. The light source is disposed inside the accommodating space. A distance between the E-paper display panel and the cover plate is greater than a distance between the light source and the cover plate, and the light source is located at the border region. The viewing angle limiting structure is disposed on a light propagating path from a light-emitting surface of the light source to the peripheral visible region of the cover plate.

In an embodiment of the invention, the viewing angle limiting structure is disposed on the peripheral visible region of the cover plate. An outer boundary of the viewing angle limiting structure is adjacent to the border region, and an inner boundary of the viewing angle limiting structure is substantially aligned with the boundary of the display region.

In an embodiment of the invention, the viewing angle limiting structure is disposed in front of the light-emitting surface of the light source and located in the border region.

In an embodiment of the invention, the cover plate includes a light-transmitting plate and a light-shielding structure. The light-shielding structure is disposed on the light-transmitting plate to form the border region, and an inner boundary of the light-shielding structure defines the visible region.

In an embodiment of the invention, the light source includes light-emitting elements located at two opposite sides of the visible region. The light-emitting elements are disposed facing each other, and a light emitted by the light-emitting elements is suitable for mixing in the accommodating space between the E-paper display panel and the cover plate.

In an embodiment of the invention, the viewing angle limiting structure includes a viewing angle filter.

In an embodiment of the invention, the viewing angle limiting structure includes an optical coating.

In an embodiment of the invention, a viewing angle of the viewing angle limiting structure is less than and equal to 30 degrees.

In an embodiment of the invention, a ratio of the distance between the E-paper display panel and the cover plate to a width of the peripheral visible region is X, and tan⁻¹ X is 25° to 35°.

In an embodiment of the invention, a lateral distance between the light-emitting surface of the light source and an inner boundary of the border region is 20 mm to 40 mm.

Based on the above, the display device of an embodiment of the invention is provided with the viewing angle limiting structure between the light source and the cover plate. The viewing angle limiting structure may suppress the light emitted directly from the light source without blocking the display region, helping to reduce viewing discomfort. In particular, at a large viewing angle, the light leakage caused by the light directly emitted by the light source may be significantly alleviated, thus satisfying a variety of application environments.

### BRIEF DESCRIPTION OF THE DRAWINGS

FIG. 1 is a schematic diagram of an example display device.

FIG. 2 is a partial schematic diagram of a display device of an embodiment.

FIG. 3 is a partial schematic diagram of a display device of an embodiment.

### DESCRIPTION OF THE EMBODIMENTS

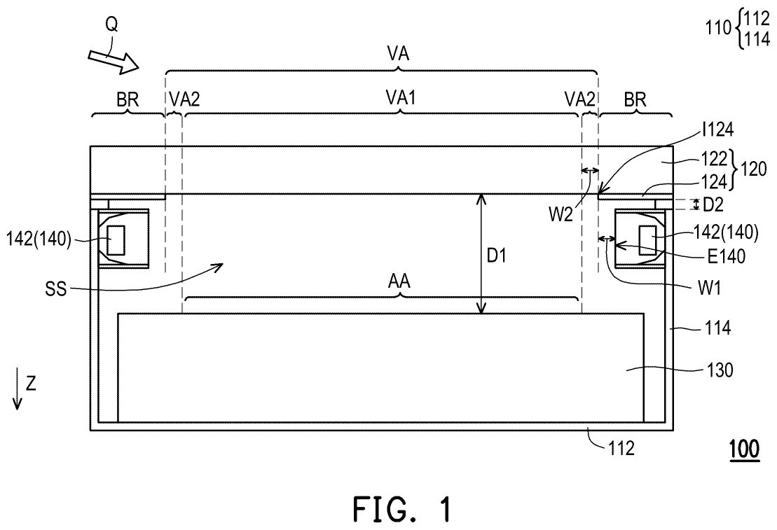

FIG. 1 is a schematic diagram of an example display device. A display device 100 at least includes a housing 110, a cover plate 120, an E-paper display panel 130, and a light source 140. The housing 110 includes, for example, a bottom plate 112 and a sidewall 114 connected around the bottom plate 112, wherein the sidewall 114 may surround the bottom plate 112 to form a shell-like structure having an opening. The cover plate 120 is disposed on the housing 110 and covers the opening of the housing 110, so that the cover plate 120 and the housing 110 define an accommodating space SS. The E-paper display panel 130 is disposed inside the accommodating space SS, and the light source 140 is also disposed inside the accommodating space SS.

The display device 100 in FIG. 1 adopts a reflective display technique to implement the display function. Specifically, the E-paper display panel 130 is, for example, disposed on the bottom plate 112 of the housing 110, and the light source 140 is, for example, disposed on the sidewall 114 of the housing 110. The light source 140 is closer to the cover plate 120 than the E-paper display panel 130. A light-emitting surface E140 of the light source 140 may face the accommodating space SS. The light emitted by the light source 140 is uniformly mixed in the accommodating space SS and then irradiated to the E-paper display panel 130. After the E-paper display panel 130 receives light, individual display pixels reflect the corresponding light to travel toward the cover plate 120 and through the cover plate 120 for viewing by the user. The light source 140 is closer to the user than the E-paper display panel 130, thus forming a reflective display device.

In some embodiments, the cover plate 120 may include a light-transmitting plate 122 and a light-shielding structure 124, wherein the light-shielding structure 124 is disposed on the light-transmitting plate 122 to form a border region BR, and an inner boundary 1124 of the light-shielding structure 124 defines a visible region VA. As a result, the cover plate 120 may have the visible region VA and the border region BR surrounding the visible region VA. The light-transmitting plate 122 may be a plate structure having high visible light transmittance, such as a glass plate, a light-transmitting plastic plate, etc. The light-shielding structure 124 may be a layered structure formed by ink, resin, metal material, or a combination thereof. The light-shielding structure 124 may be formed on the light-transmitting plate 122 by printing, deposition, pasting, or other similar methods to define the border region BR. In other words, the area occupied by the light-shielding structure 124 is the border region BR, and the light-shielding structure 124 is an area having very low visible light transmittance. The cover plate 120 may be disposed on the housing 110 via mechanical assembly, lamination, or a combination of the above methods, so as to define the accommodating space SS with the housing 110.

The E-paper display panel 130 adopts an E-paper display technique to implement the display function. The E-paper display panel 130 has a display region AA, wherein the display region AA may be an area where the display pixels of the E-paper display panel 130 are disposed, and may also be understood as an area where the E-paper display panel 130 is used to display an image. In some embodiments, the boundary of the display region AA may be defined by display pixels disposed at the boundary in the E-paper display panel 130.

The light source 140 may be located in the border region BR, so that the light-shielding structure 124 may block the light source 140 and prevent the user from directly seeing the light source 140. In some embodiments, the border region BR is extended toward the center by a lateral distance W1 from the light-emitting surface E140 of the light source 140 to reliably shield the light source 140, wherein the lateral distance W1 is, for example, 20 mm to 40 mm, or, for example, 30 mm, but is not limited thereto. The light source 140 may include light-emitting elements 142 located at two opposite sides of the visible region VA, such as a light bar, a light array, or the like. The light-emitting elements 142 are disposed to face each other (that is, the light-emitting surfaces E140 face each other). A distance D1 between the E-paper display panel 130 and the cover plate 120 may be greater than a distance D2 between the light source 140 and the cover plate 120. In this way, the light emitted by the light-emitting elements 142 may be emitted from two sides to the center and fully mixed in the accommodating space SS to provide a uniform light source to the E-paper display panel 130. In some embodiments, the distance D1 between the E-paper display panel 130 and the cover plate 120 may be, for example, 30 mm to 75 mm to provide sufficient light mixing space without causing excessive reduction in display brightness.

In some embodiments, in a viewing direction Z perpendicular to the E-paper display panel 130, the boundary of the display region AA of the E-paper display panel 130 is retracted inwardly with respect to the boundary of the visible region VA of the cover plate 120. In some embodiments, the visible region VA of the cover plate 120 has, or is divided into, a center visible region VA1 aligned with the display region AA and a peripheral visible region VA2 located between the center visible region VA1 and the border region BR. Both the center visible region VA1 and the peripheral visible region VA2 have higher visible light transmittance than the border region BR, thereby allowing display light to pass through. The design that the visible region VA is greater than the display region AA may increase the viewing angle range of the display device 100 to improve the practicality of the display device 100. For example, when the display device 100 is applied to a large-sized advertising billboard, a large viewing angle range is beneficial.

In some embodiments, the greater a width W2 of the peripheral visible region VA2 is, the wider the viewing angle range is. However, as a result, the border region BR needs to be expanded laterally outward, resulting in an increase in the width of the device. Therefore, the width W2 of the peripheral visible region VA2 may be adjusted according to different design requirements. For example, the ratio (W2/D1) of the width W2 of the peripheral visible region VA2 to the distance D1 between the E-paper display panel 130 and the cover plate 120 is, for example, X, and tan⁻¹ X may be 25° to 35°. This is beneficial to providing the effect of clearly seeing the display information of the boundary of the display region AA from a viewing angle range of about 30 degrees, but is not limited thereto. In some embodiments, tan⁻¹ X may be 30°, but is not limited thereto.

The design of the peripheral visible region VA2 increases the display viewing angle of the display device 100, while in order to maintain the size of the device and/or provide a narrow border design, the border region BR may need to be reduced. Under this circumstance, when viewing the display in a tilt direction Q, the viewer may see light directly emitted by the light source 140 (that is, light leakage), resulting in significant bright area. If the display device 100 is applied to an outdoor large-sized advertising billboard, such light leakage may irritate the eyes of drivers or pedestrians, thus affecting traffic safety. The following description will be combined with the drawings to illustrate some specific implementations of the display device 100 that may improve the display quality of the display device 100 and alleviate the above light leakage situation. For convenience of explanation, individual members described in FIG. 1 may be incorporated into the following embodiments.

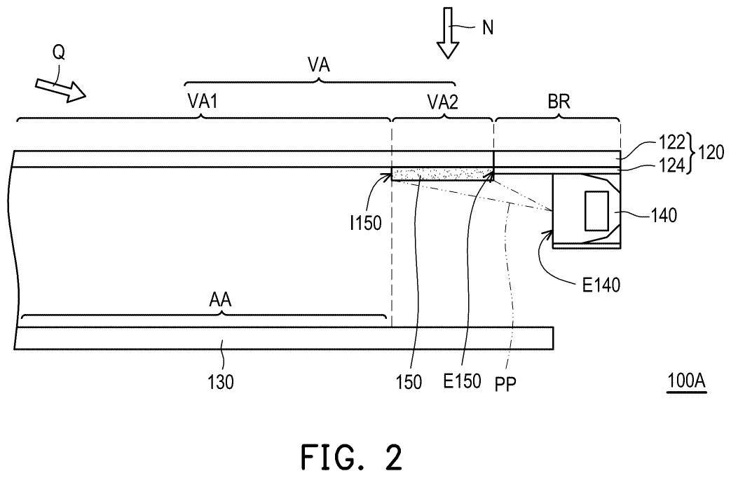

FIG. 2 is a partial schematic diagram of a display device of an embodiment. A display device 100A in FIG. 2 includes all the components described in FIG. 1, but for convenience of explanation, FIG. 2 only shows the cover plate 120, the E-paper display panel 130, and the light source 140, wherein the arrangement, structure, function, etc. of the cover plate 120, the E-paper display panel 130, and the light source 140 are as provided in the description of FIG. 1, and the description of the housing 110 in FIG. 1 may also be incorporated into the present embodiment. In addition, the display device 100A of FIG. 2 further includes a viewing angle limiting structure 150. The viewing angle limiting structure 150 may be disposed on a light propagating path PP from the light-emitting surface E140 of the light source 140 to the peripheral visible region VA2 of the cover plate 120.

In the present embodiment, the viewing angle limiting structure 150 is disposed on the peripheral visible region VA2 of the cover plate 120. An outer boundary E150 of the viewing angle limiting structure 150 is adjacent to the border region BR, and an inner boundary 1150 of the viewing angle limiting structure 150 is substantially aligned with the boundary of the screen display region AA. In this way, the viewing angle limiting structure 150 is substantially parallel to the light-transmitting plate 122.

In some embodiments, the viewing angle limiting structure 150 may include a viewing angle filter. The viewing angle filter may be an optical film having microstructures to limit the viewing angle range. When the viewing angle limiting structure 150 is a prefabricated optical film, the viewing angle limiting structure 150 may be attached on the inner surface of the light-transmitting plate 122 of the cover plate 120 facing the E-paper display panel 130, and the viewing angle limiting structure 150 may be closely attached or floatingly attached on the light-transmitting plate 122. When the viewing angle limiting structure 150 is an optical layer directly formed on the light-transmitting plate 122, the viewing angle limiting structure 150 may be formed on the light-transmitting plate 122 via a coating method. In some embodiments, the viewing angle limiting structure 150 may include an optical coating including a multilayer structure formed by stacking thin layers with different refractive indexes. In this instance, the viewing angle limiting structure 150 may be formed on the cover plate 120 via a coating method.

The viewing angle of the viewing angle limiting structure 150 is less than and equal to 30 degrees. In this way, the viewing angle limiting structure 150 may block and/or absorb the light emitted by the light source 140 through the tilt direction Q. In other words, when viewing the image displayed by the display device 100A through the tilt direction Q, the viewer may not readily see the light leakage from the light source 140. At the same time, when viewed through a front direction N, the display light from the E-paper display panel 130 is not blocked and/or absorbed by the viewing angle limiting structure 150, and may provide good display brightness.

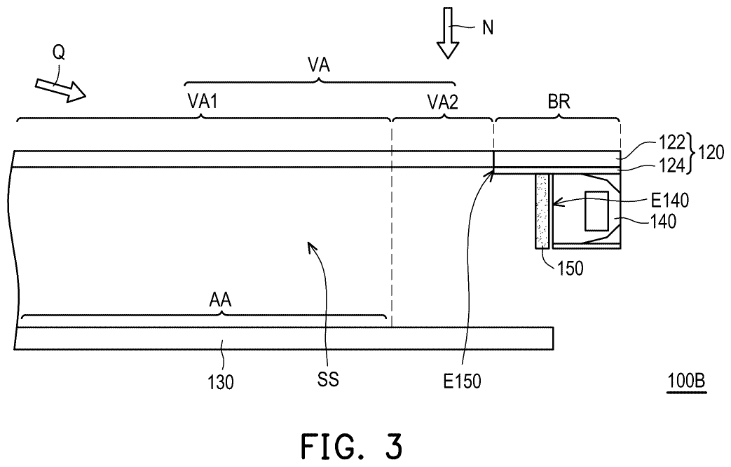

FIG. 3 is a partial schematic diagram of a display device of an embodiment. A display device 100B of FIG. 3 has the same constituting members as the display device 100A, but the position of the viewing angle limiting structure 150 in the display device 100B is different from that of the display device 100A. Therefore, the descriptions of members other than the viewing angle limiting structure 150 in the two embodiments are analogous. Also, the descriptions of the housing 110, the cover plate 120, the E-paper display panel 130, and the light source 140 in FIG. 1 may also be incorporated into the present embodiment.

As shown in FIG. 3, the viewing angle limiting structure 150 is disposed in front of the light-emitting surface E140 of the light source 140 and located in the border region BR. Similar to the above embodiments, the viewing angle limiting structure 150 may be attached to the light-emitting surface E140 or coated on the light-emitting surface E140. The viewing angle limiting structure 150 may include a viewing angle filter or an optical coating.

The viewing angle of the viewing angle limiting structure 150 is, for example, less than and equal to 30 degrees, and the viewing angle limiting structure 150 is disposed in front of the light-emitting surface E140 of the light source 140. Therefore, the light emitted by the light source 140 is mainly emitted toward the accommodating space SS, and the light emitted obliquely is blocked and/or absorbed by the viewing angle limiting structure 150. As a result, when viewing the image displayed by the display device 100A through the tilt direction Q, the light leakage from the light source 140 is not readily seen. At the same time, the light emitted toward the accommodating space SS is not significantly blocked and/or absorbed, so that the display device 100B may maintain good display brightness.

Based on the above, the display device of an embodiment of the invention has the light source independently disposed in front of the E-paper display panel, and the viewing angle limiting structure is disposed on the light propagating path of the light source toward the cover plate. In this way, when the display is viewed at an oblique angle, light leakage from the light source may be suppressed and a uniform display effect may be provided, thus helping to improve the display quality of the display device. When the display device is applied to outdoor billboards, the viewing angle limiting structure may suppress light leakage at large viewing angles, helping to prevent the viewer's ongoing behavior (such as driving, walking, etc.) from being affected by visual stimulation caused by light leakage, thus maintaining traffic safety. In addition, the display effect of suppressing light leakage at large viewing angles also makes the viewer's visual experience more comfortable.

What is claimed is:

1. A display device, comprising:
a housing;
a cover plate disposed on the housing, wherein the cover plate and the housing define an accommodating space, and the cover plate has a visible region and a border region surrounding the visible region;
an E-paper display panel disposed inside the accommodating space, wherein the E-paper display panel has a display region, and in a viewing direction perpendicular to the E-paper display panel, a boundary of the display region is retracted inwardly with respect to a boundary of the visible region, so that the visible region of the cover plate has a center visible region aligned with the display region and a peripheral visible region located between the center visible region and the border region;
a light source disposed in the accommodating space, wherein a distance between the E-paper display panel and the cover plate is greater than a distance between the light source and the cover plate, and the light source is located at the border region; and
a viewing angle limiting structure disposed on a light propagating path from a light-emitting surface of the light source to the peripheral visible region of the cover plate.

2. The display device of claim 1, wherein the viewing angle limiting structure is disposed on the peripheral visible region of the cover plate.

3. The display device of claim 2, wherein an outer boundary of the viewing angle limiting structure is adjacent to the border region, and an inner boundary of the viewing angle limiting structure is substantially aligned with the boundary of the display region.

4. The display device of claim 1, wherein the viewing angle limiting structure is disposed in front of the light-emitting surface of the light source and located in the border region.

5. The display device of claim 1, wherein the cover plate comprises a light-transmitting plate and a light-shielding structure, the light-shielding structure is disposed on the light-transmitting plate to form the border region, and an inner boundary of the light-shielding structure defines the visible region.

6. The display device of claim 1, wherein the light source comprises light-emitting elements located at two opposite sides of the visible region.

7. The display device of claim 1, wherein the light-emitting elements are disposed facing each other, and a light emitted by the light-emitting elements is suitable for mixing in the accommodating space between the E-paper display panel and the cover plate.

8. The display device of claim 1, wherein the viewing angle limiting structure comprises a viewing angle filter.

9. The display device of claim 1, wherein the viewing angle limiting structure comprises an optical coating.

10. The display device of claim 1, wherein a viewing angle of the viewing angle limiting structure is less than and equal to 30 degrees.

11. The display device of claim 1, wherein a ratio of the distance between the E-paper display panel and the cover plate to a width of the peripheral visible region is X, and tan⁻¹ X is 25° to 35°.

12. The display device of claim 1, wherein a lateral distance between the light-emitting surface of the light source and an inner boundary of the border region is 20 mm to 4 mm.
